(19) United States
(12) Patent Application Publication
(10) Pub. No.: US 2025/0385445 A1
(43) Pub. Date: Dec. 18, 2025

(54) ELECTRICAL CONNECTOR

(71) Applicant: Viper Innovations Limited, Bristol (GB)

(72) Inventors: Steven Simpson, Bristol (GB); Simon Moss, Bristol (GB); Ralph Knoyle, Bristol (GB)

(21) Appl. No.: 19/106,920

(22) PCT Filed: Aug. 24, 2023
(86) PCT No.: PCT/GB2023/052202

§ 371 Date: Feb. 26, 2025

(30) Foreign Application Priority Data
Aug. 30, 2022 (GB) 2212535.5

(51) Int. Cl. H01R 4/48; H01R 13/44; H01R 13/688

(52) U.S. Cl. CPC H01R 4/48; H01R 13/44; H01R 13/688

(57) ABSTRACT

An electrical connector for connecting an electrical equipment to an electrical terminal. The electrical connector comprises a housing having an opening in communication with an interior of the housing and an electrically conductive contact disposed within the interior of the housing. The electrically conductive contact is accessible via the opening and comprises an aperture for receiving the electrical terminal. The contact is moveable relative to the housing between a first position and a second position. The first position permits the electrical terminal to be inserted through the opening and into the aperture. The second position is configured to retain the electrical terminal in the aperture.

### FIELD OF THE INVENTION

The present disclosure relates to an electrical connector. In particular, the disclosure relates to an electrical connector for connecting an electrical equipment to an electrical terminal.

### BACKGROUND

Electrical connectors are commonly used to create an electrical connection between parts of an electrical circuit, or between different electrical circuits, thereby joining them into a larger circuit. For example, electrical connectors can be used to connect an electrical equipment to a power supply network.

One example of a power supply network is a rail signalling power supply network. The rail signalling power supply network usually comprises a Principal Supply Point (PSP) which provides an electrical power supply to multiple Signalling Apparatus Housings (SAHs). The SAHs provide a protective enclosure for critical electrical equipment and the distribution of power necessary for the operation of the signalling system. Electrical terminals within the PSP and the SAH usually take the form of a bolt or a stud. Retrofitting or replacing electrical equipment in the PSP and the SAHs is sometimes required.

Existing methods of installing electrical equipment into the PSP and SAH enclosures require the power supply to be switched off, so that electrical connections can be made safely. This means that, in order to reduce impact on the rail network, installations can only be completed at pre-planned times, when it is possible to switch off the power supply. These restrictions can delay the installation of equipment.

An electrical connector that could enable personnel to safely and reliably install and connect electrical equipment to the power supply network, without requiring the power to be switched off, would significantly reduce the operational impact of the installation process. Currently available electrical connectors (e.g. crocodile clips) are unable to provide a suitable, reliable or safe solution for connecting electrical equipment to live bolt or stud electrical terminals.

### SUMMARY

The present disclosure provides an electromechanical device for connecting an electrical equipment to an electrical terminal.

According to a first aspect of the invention, there is provided an electrical connector for connecting an electrical equipment to an electrical terminal. The electrical connector may comprise a housing having an opening in communication with an interior of the housing. The electrical connector may comprise an electrically conductive contact disposed within the interior of the housing and accessible via the opening. The contact may have an aperture for receiving the electrical terminal. The contact may be moveable relative to the housing between a first position and a second position. The first position may permit the electrical terminal to be inserted through the opening and into the aperture. The second position may be configured to retain the electrical terminal in the aperture.

The electrical connector may be configured to connect the electrical equipment to a live electrical terminal. Typically, in order to connect an electrical equipment to an electrical terminal, the power supply to the terminal has to be switched off. This ensures that a user installing the electrical equipment is prevented from inadvertently receiving an electric shock. However, when the power supply is switched off, any other electrical equipment connected to the power supply cannot perform its function. This may pose an unacceptable disruption. As such, the electrical connector disclosed herein is advantageous because it allows a user to safely connect the electrical equipment to a live electrical terminal.

The electrically conductive contact may be connectable to the electrical equipment. For example, the contact may be connectable to the electrical equipment via an electrical wire or cable.

The electrical equipment may comprise any type of electrical load. For example, the electrical equipment may comprise an inductive load, a resistive load and/or a capacitive load. In some embodiments, the electrical equipment may be used in the rail industry. For example, the electrical equipment may be used to control signalling lights, track points, points heaters, level crossings or similar. Additionally or alternatively, the electrical equipment may comprise switchgear equipment, communication equipment and/or monitoring equipment. The electrical equipment may be installed in a signalling apparatus housing (SAH) within a signalling power supply (SPS) network. It is to be appreciated that the above examples of the electrical equipment are not an exhaustive list.

The electrical connector disclosed herein is particularly useful in railway applications, as it allows equipment installations to be completed with minimal impact on the rail network. Specifically, the electrical connector enables personnel to install and connect equipment at any time of day, without requiring the power to be switched off and whilst trains are operating.

The housing may be electrically insulating. For example, the housing may be constructed out of an electrically insulating material. Additionally or alternatively, the housing may be coated or encased in an electrically insulating material.

Advantageously, the electrically insulated housing allows a user to safely connect and/or remove (disconnect) the electrical equipment from the live electrical terminal. The user can handle the insulated housing without touching the electrically conductive contact or the live electrical terminal. More specifically, the user can move the contact between the first position and the second position without receiving an electric shock.

The housing may surround the electrically conductive contact on all sides apart from the opening. For example, the contact may be enclosed by the housing and may only be accessible through the opening of the housing. This further decreases the risk of the user accidentally touching the contact when moving the contact between the first position and the second position. Furthermore, the housing also surrounds the electrical terminal when the electrical contact is being connected thereto, and thus decreases the risk of the user accidentally touching the electrical terminal when the connector is connected thereto. The housing may comprise a single opening. In such arrangements, the contact may be enclosed by the housing and only accessible through the single opening of the housing. In other words, the contact is accessible through a single access point only.

The electrical terminal may comprise a bolt or a stud. The bolt or the stud may have a substantially cylindrical shape. An external surface of the bolt or the stud may be threaded (i.e. a screw thread may be formed on the external surface of the bolt or stud).

The aperture of the electrically conductive contact may be substantially circular. Alternatively or additionally, the opening of the housing may be substantially circular. In other words, the contact and/or the opening have an internal surface with a substantially circular shape (when viewed along the axis of the contact and/or opening). The circular shape of the aperture and/or the opening may be especially useful for retaining the electrical terminal when the contact is in the second position. For example, if the electrical terminal comprises a bolt or a stud having an outer surface with a substantially circular shape, the corresponding circular shape of the aperture and/or the opening provides a large contact surface between the outer surface of the terminal and the internal surface(s) of the aperture and/or the opening. This helps to avoid the electrical terminal being dislodged when the contact is in the second position. In this manner, the shape of the aperture and/or the opening reduces the risk of the contact disconnecting from the terminal.

The circular shape of the aperture of the contact may also improve the quality of the electrical connection between the contact and a terminal in the form of a bolt or stud with a substantially circular shape. The larger contact surface between the electrically conductive contact and the terminal leads to a larger surface area available for the passage of current. This in turn reduces the electrical resistance and the amount of power dissipated between the contact and the terminal. In this manner, the safety and the efficiency of the electrical connection is increased.

In some examples, the aperture of the electrically conductive contact may be substantially square or rectangular. Alternatively or additionally, the opening of the housing may be substantially square or rectangular. The square or rectangular shape of the aperture and/or the opening may be especially useful for retaining the electrical terminal when the contact is in the second position. For example, if the electrical terminal comprises a bolt or a stud having an outer surface with a substantially square or rectangular shape, the corresponding square or rectangular shape of the aperture and/or the opening provides a large contact surface between the outer surface of the terminal and the internal surface(s) of the aperture and/or the opening. This helps to avoid the electrical connector being dislodged when the contact is in the second position and may also improve the quality of the electrical connection between the contact and a terminal in the form of a bolt or stud with a substantially square or rectangular shape. More generally, the shape and dimensions of the aperture and/or opening can be chosen to correspond to the shape and dimensions of a given electrical terminal, so as to ensure a good electrical contact and to reduce the risk of the connector being dislodged from the terminal.

The aperture of the contact may be aligned with the opening of the housing when the contact is in the first position. For example, the aperture may be concentric with the opening when the contact is in the first position. Alternatively or additionally, the aperture and opening may have the same shape and size, such that there is a continuous passage through the aperture and opening when the contact is in the first position. An internal area defined by the aperture and the opening may be larger than the cross-sectional area defined by an end of the terminal. This allows the terminal to be easily inserted through the opening and into the aperture, when the contact is in the first position.

In some implementations, the housing may comprise a first opening and a second opening. The first opening may be aligned with, and spaced apart from, the second opening. The aperture of the contact may be aligned with the first opening and the second opening of the housing when the contact is in the first position. For example, the aperture may be concentric with the first and the second opening when the contact is in the first position. Alternatively or additionally, the aperture and the first and the second opening may have the same shape and size, such that there is a continuous passage through the aperture and the first and the second openings when the contact is in the first position. The electrical terminal may be insertable through the first opening, the aperture and the second opening when the contact is in the first position. The terminal may protrude through the second opening, or may otherwise be exposed via the second opening. By allowing the electrical terminal to remain exposed, the electrical connector of these implementations can allow multiple connections to be made to a particular terminal. It will be appreciated that such implementations do not provide the same level of protection against electrical shock as the other implementations described herein, in which the electrical terminal is surrounded by the connector in use.

The opening of the housing and/or the aperture of the contact may comprise a surface feature for engaging with an external surface of the electrical terminal. The surface feature may extend from an inner edge of the aperture. Additionally or alternatively, the surface feature may extend from an inner edge of the opening.

The surface feature may comprise a v-shaped protrusion for engaging with a screw thread on the external surface of the electrical terminal. The v-shaped protrusion may have a substantially wedge-shaped profile. The aperture may comprise a first v-shaped protrusion and the opening may comprise a second v-shaped protrusion. The aperture and/or the opening may comprise multiple v-shaped protrusions. Additionally or alternatively, the internal surface of the aperture and/or the opening may comprise (at least a portion of) a screw thread for engaging with the screw thread on the external surface of the electrical terminal.

Advantageously, the surface feature may be specifically shaped to engage with the threaded surface of the terminal, thereby allowing the aperture and/or the opening to maintain a good engagement with the terminal. This further reduces the risk of the electrical terminal becoming dislodged when the contact is in the second position.

The surface feature may be used to remove impurity layers and/or corrosion from the terminal, as the terminal is inserted through the opening and into the aperture. For example, the surface feature may be configured to scrape off impurity layers or corrosion from the external surface of the terminal. This further improves the quality of the electrical connection between the contact and the terminal, when the contact is in the second position. Moreover the surface feature may be used to safely remove impurity layers and/or corrosion from the terminal, even when the terminal is live.

The housing and an internal surface of the aperture of the contact may be configured to apply a compressive force to the electrical terminal when the contact is in the second position. The compressive force may be configured to retain the electrical terminal within the aperture, when the contact is in the second position.

The electrical connector may further comprise a biasing mechanism. The biasing mechanism may be configured to urge the contact towards the second position. The biasing mechanism may comprise a spring. The spring may comprise a helical spring and/or a leaf spring. Additionally or alternatively, the biasing mechanism may comprise a rack and pinion style mechanism and/or a compression latch mechanism. It is to be appreciated that the above examples of the biasing mechanism are not an exhaustive list.

The biasing mechanism may be configured to clamp the electrical terminal between the housing and the internal surface of the aperture of the contact. For example, the biasing mechanism may be configured to clamp the electrical terminal between an upper internal surface of the aperture and a lower internal surface of the opening. In this manner, the biasing mechanism applies the compressive force to the electrical terminal and retains the electrical terminal in the aperture, when the contact is in the second position. This reduces the risk of the connector being dislodged by external forces.

The housing may comprise a stem, and a cap at least partially overlapping the stem. The cap may comprise the opening. The cap may be slidably mounted on the stem. The stem may comprise a strain-relief gland. The strain-relief gland may be configured to receive an electrical wire connected to the electrical equipment. The strain-relief gland may provide strain relief for the electrical wire or cable. The cap may comprise a main body and a collar. The collar may be connected to the main body. The main body may comprise the opening. One of the main body and the collar may comprise at least one retaining clip configured to engage with a corresponding retention feature located on the other of the main body and the collar to connect the main body and the collar.

The contact may be connected to the stem. The contact may be disposed within the cap. Both the contact and the stem may be moveable relative to the cap, between the first position and the second position

The biasing mechanism may be configured to urge the cap away from the stem. For example, the biasing mechanism may be positioned between the cap and the stem, and arranged so as to push the cap and stem apart.

The housing may comprise one or more formations to enable a user to move the contact between the first position and the second position. The one or more formations may comprise: a first shoulder coupled to the cap; and a second shoulder coupled to the stem. For example, the first and/or second shoulders may be integrally formed with the cap and/or stem, respectively, or the first and/or second shoulders may be separate components that are connected to the cap and/or stem, respectively. Additionally or alternatively, the one or more formations may comprise one or more indentations in the housing. For example, the one or more formations may comprise a first indentation in the cap and a second indentation in the stem. The one or more formations may be coated in a gripping material. The gripping material may allow the user to easily hold the housing and move the contact between the first position and the second position.

To move the contact into the first position, the user may hold the first shoulder and the second shoulder to squeeze the cap and the stem together. For example, the user may place one or more fingers on top of the first shoulder and their thumb underneath the second shoulder. The user may squeeze their fingers and thumb together to compress the biasing mechanism, thereby moving the cap towards the stem. This motion moves the contact into the first position. When the contact is in the first position, the electrical terminal may be inserted through the opening and into the aperture of the contact. The user may subsequently release the first shoulder and the second shoulder, allowing the contact to move towards the second position, under the influence of the biasing mechanism.

The electrical connector may further comprise a finger guard. The finger guard may be connected to the first shoulder. The finger guard may be configured to prevent the user from touching the electrical terminal when moving the contact between the first position and the second position. The finger guard further reduces the risk of a user receiving an electric shock when connecting the electrical equipment to the live electrical terminal using the electrical connector.

The stem may comprise a fuse holder for receiving a fuse. The fuse holder may comprise a chamber for housing the fuse. The fuse holder may be connectable to the contact at one end.

The electrical connector may further comprise a fuse. The fuse may be connectable between the electrical equipment and the contact. The fuse may be disposed within the housing. Specifically, the fuse may be disposed within the fuse holder.

When electrical equipment is installed into a power supply network, a fuse is usually required between the electrical equipment and the power supply in order to protect the electrical equipment in the event of a fault developing. This traditionally complicates the installation process, since the electrical equipment and the fuse are distinct components that have to be installed separately. In contrast, by including an integral fuse in the electrical connector as disclosed herein, the installation process is simplified.

The fuse may be replaceable when the contact is in the second position. For example, the fuse may be safely replaceable when the electrical connector is connected to the live electrical terminal. The housing may comprise one or more ridges that are configured to hold the fuse in position. For example, the stem may comprise the one or more ridges. The one or more ridges may act to prevent the fuse from dropping out of the fuse holder during the replacement or installation process. This simplifies the fuse replacement or installation process, and ensures that a user does not have to touch the live elements of the electrical connector or terminal when replacing the fuse.

The electrical connector may further comprise a first fuse connector. The first fuse connector may be connectable between the contact and the fuse. The electrical connector may further comprise a second fuse connector. The second fuse connector may be connectable between the fuse and the electrical equipment. In some embodiments, the second fuse connector may be connectable to the electrical equipment via the electrical wire or cable. The first fuse connector may be configured to urge the fuse against the second fuse connector.

The first fuse connector may provide an electrical connection between the contact and the fuse. The first fuse connector may be resilient. For example, the first fuse connector may comprise a spring. The spring may comprise a helical spring, a leaf spring or a flat spring. Preferably, the first fuse connector comprises a beryllium-copper strip. Beryllium-copper has a high conductivity and good mechanical properties and, therefore, is a particularly suitable material for the first fuse connector. It will be appreciated that other suitable materials may be used. The resilient nature of the first fuse connector may be configured to urge the fuse against the second fuse connector. By allowing the first fuse connector to urge the fuse against the second fuse connector, a good electrical connection is maintained between the fuse connectors and the fuse.

The second fuse connector may provide an electrical connection between the fuse and an electrical wire or cable connectable to the electrical equipment. The second fuse connector may comprise a crimp terminal. The second fuse connector may be easily assembled onto an end of the electrical wire or cable using a standard crimp tool.

### BRIEF DESCRIPTION OF THE FIGURES

Embodiments will now be described, purely by way of example, with reference to the accompanying drawings, in which:

FIG. 1 shows an exploded rear side view of an electrical connector;

FIG. 2 shows a rear isometric view of the electrical connector of FIG. 1;

FIG. 3 shows a front isometric view of the electrical connector of FIGS. 1 and 2;

FIG. 4a shows a rear side view of the electrical connector of FIGS. 1 to 3;

FIG. 4b shows a cross-sectional view of the electrical connector along the plane X depicted in FIG. 4a;

FIG. 5 shows a partially exploded rear isometric view of the electrical connector of FIGS. 1 to 4;

FIG. 6 shows a cross-sectional view of the electrical connector of FIGS. 1 to 5 in an uncompressed position;

FIG. 7 shows a cross-sectional view of the electrical connector of FIGS. 1 to 6 in a fully compressed position;

FIG. 8a shows a front isometric view of the electrical connector of FIGS. 1 to 7 attached to an electrical terminal;

FIG. 8b shows a cross-sectional view of the electrical connector of FIGS. 1 to 7 attached to an electrical terminal;

FIG. 9a shows a partially exploded rear side view of a main body and collar of another example of an electrical connector;

FIG. 9b shows a side view of the main body and collar of the electrical connector of FIG. 9a; and

FIG. 9c shows a top view of the collar shown in FIGS. 9a and 9b.

### DETAILED DESCRIPTION

It will be understood that the use of terms such as vertical, horizontal, left, right etc. are for descriptive purposes only to aid comprehension, and thus do not preclude alternative orientations or configurations of the disclosed invention.

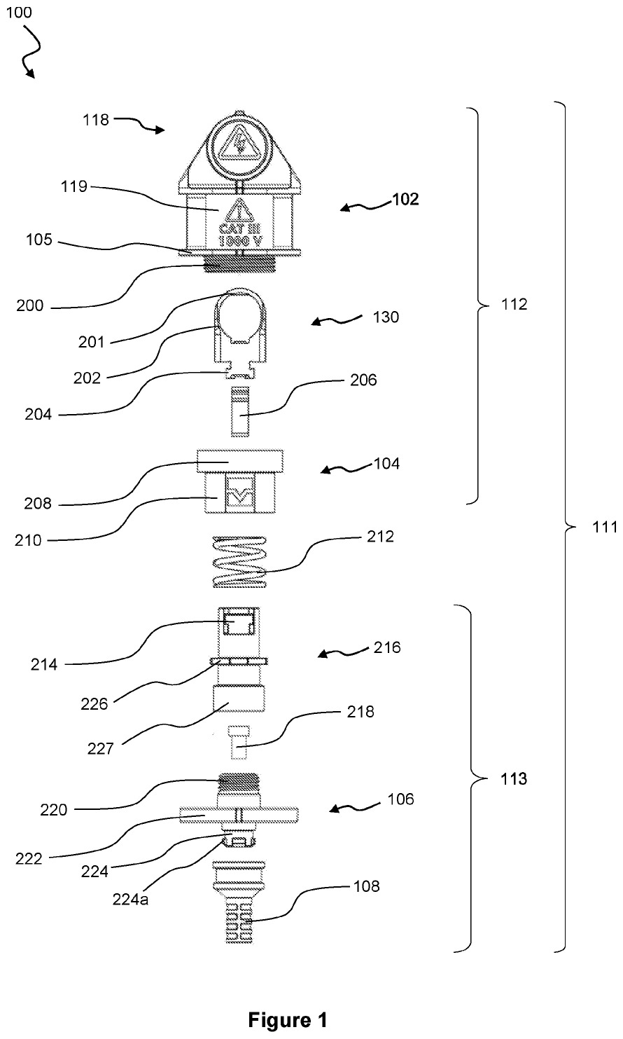

FIG. 1 shows an exploded rear side view of an electrical connector 100. As will be described in more detail below, the electrical connector 100 may be configured for connection to an electrical wire (or electrical cable) of electrical equipment. The electrical connector 100 is therefore freely moveable. This may aid the user in connecting the electrical connector 100 to an electrical terminal, particularly where the electrical terminal is fixed.

The electrical connector 100 comprises a housing 111. The housing 111 comprises a cap 112 and a stem 113. The cap 112 comprises a main body 102 and a collar 104. The stem 113 comprises a strain-relief gland 108, a base portion 106 and a fuse holder 216. The electrical connector 100 further comprises an electrically conductive contact 130, a first fuse connector 206, a second fuse connector 218 and a biasing mechanism. The biasing mechanism takes a form of a spring 212, specifically a coil spring. The second fuse connector 218 comprises a crimp terminal.

The main body 102 comprises a roof 118, a neck 119, a first shoulder 105 and a first connector, which in the arrangement of FIG. 1 is a first threaded connector 200. The roof 118 is connected to the neck 119. In turn, the neck 119 is connected to the first shoulder 105. The first shoulder 105 is connected to the first threaded connector 200. The first shoulder 105 is substantially elliptical in shape. The roof 118, the neck 119, the first threaded connector 200 and the first shoulder 105 may be integrally formed. The main body 102 comprises a hollow interior for receiving the electrically conductive contact 130, as will be described in more detail below.

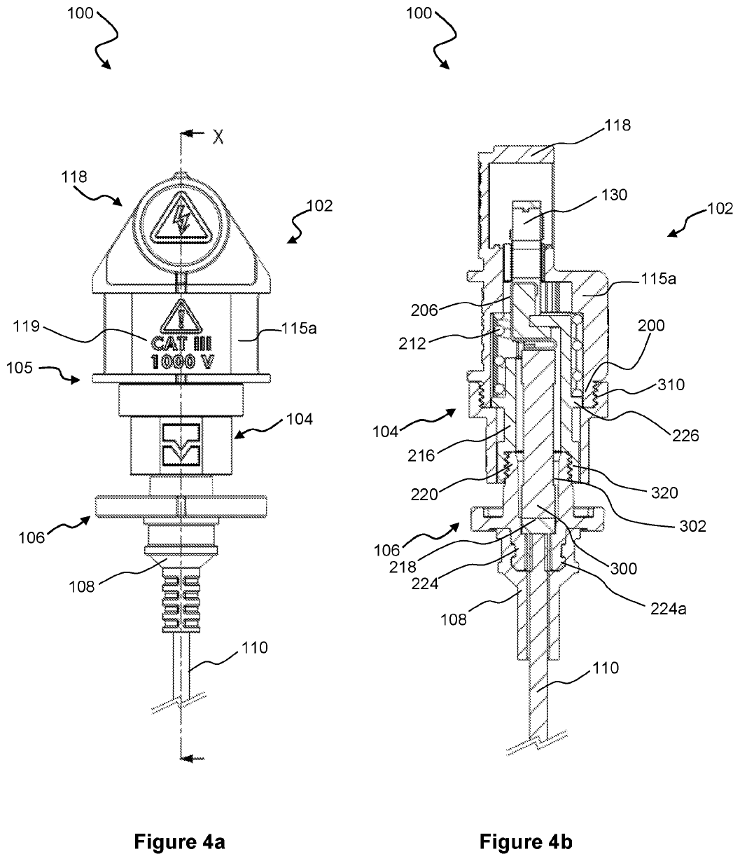

The collar 104 comprises an upper collar portion 208 and a lower collar portion 210. The circumference of the upper collar portion 208 is larger than the circumference of the lower collar portion 210. The inner surface of the upper collar portion 208 comprises a second threaded connector 310 (best seen in FIG. 4b).

The fuse holder 216 comprises a fuse chamber 214, an annular shoulder 226 and a fuse holder base 227. The annular shoulder 226 extends away from an outer surface of the fuse holder 216, thereby forming a torus-shaped projection. The annular shoulder 226 may be connected to the outer surface of the fuse holder 216. Alternatively, the annular shoulder 226 and the fuse holder 216 may be integrally formed. An inner surface of the fuse holder base 227 comprises a third threaded connector 320 (best seen in FIG. 4b).

The base portion 106 comprises a retaining portion 224, a second shoulder 222 and a fourth threaded connector 220. The retaining portion 224 comprises a raised ridge 224a that is configured to retain the strain-relief gland 108. The second shoulder 222 is substantially elliptical in shape and is connected between the fourth threaded connector 220 and the retaining portion 224. The retaining portion 224, the second shoulder 222 and the fourth threaded connector 220 may be integrally formed.

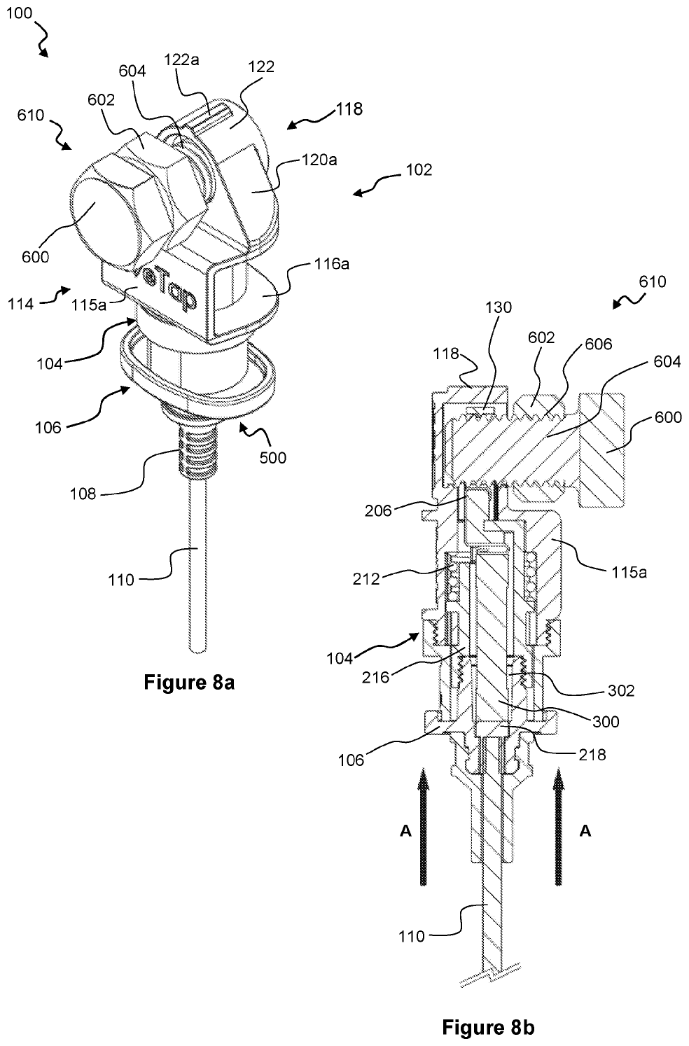

The electrically conductive contact 130 comprises an aperture 202. The aperture 202 is substantially circular in shape. The aperture 202 is configured to receive an electrical terminal as will be described with reference to FIGS. 8a and 8b. Extending from an inner edge of the aperture 202 there is provided a first v-shaped protrusion 201. The electrically conductive contact 130 further comprises a clasp 204. The electrically conductive contact 130 may comprise any suitable electrically conductive material. Preferably, the electrically conductive contact is formed from brass. The electrically conductive contact 130 may be electrically connected to an electrical wire 110 (or electrical cable), wherein the electrical wire 110 is connected to an electrical equipment. This will be described in more detail below.

The cap 112 and the stem 113 of the housing 111 are made out of, or are coated in, an insulating material. In some embodiments, the cap 112 and the stem 113 comprise a plastics material. The electrically insulated housing 111 allows a user to safely handle the electrical connector 100, when connecting/disconnecting it from a live electrical terminal.

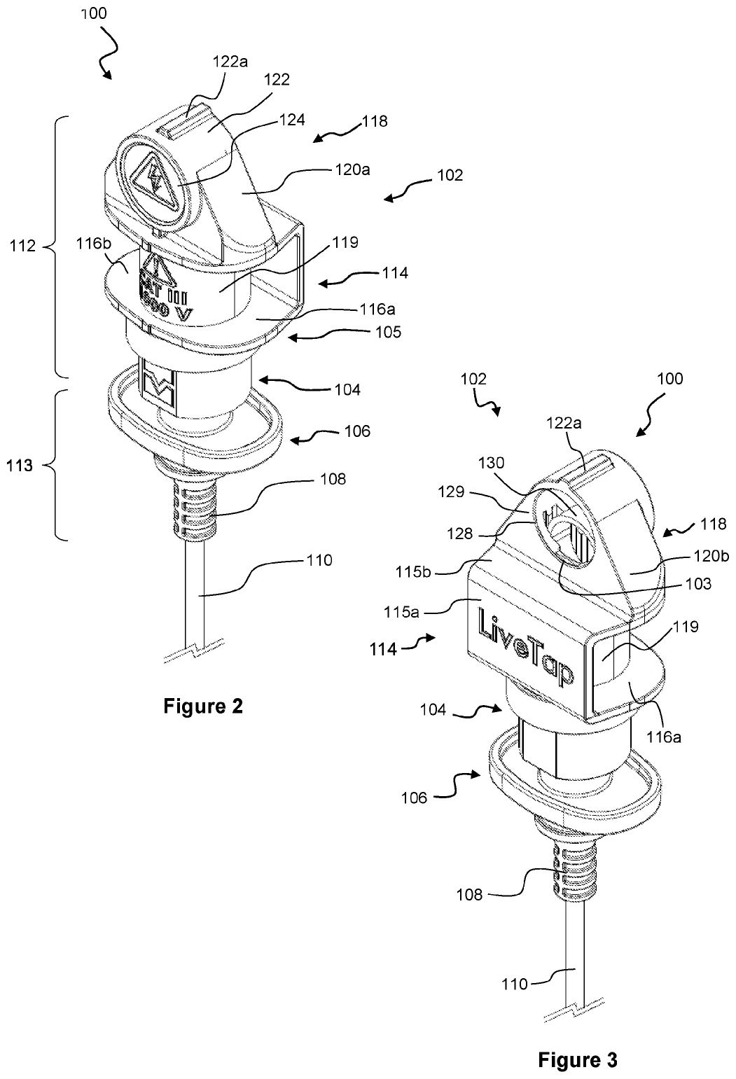

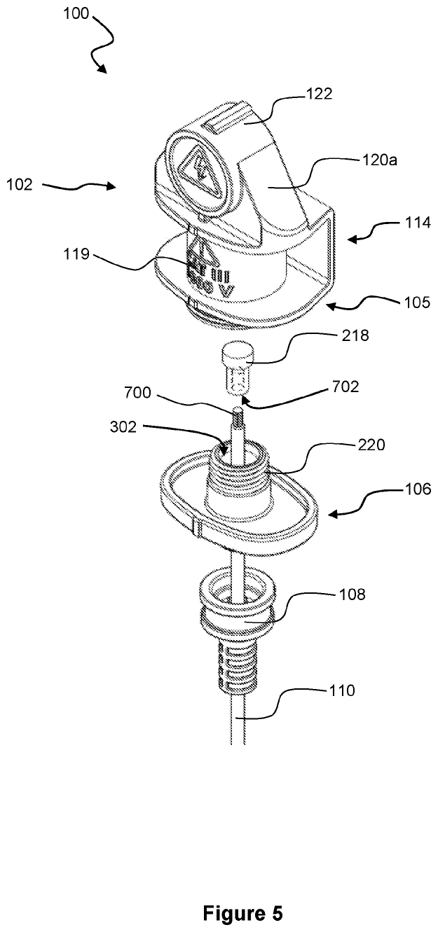

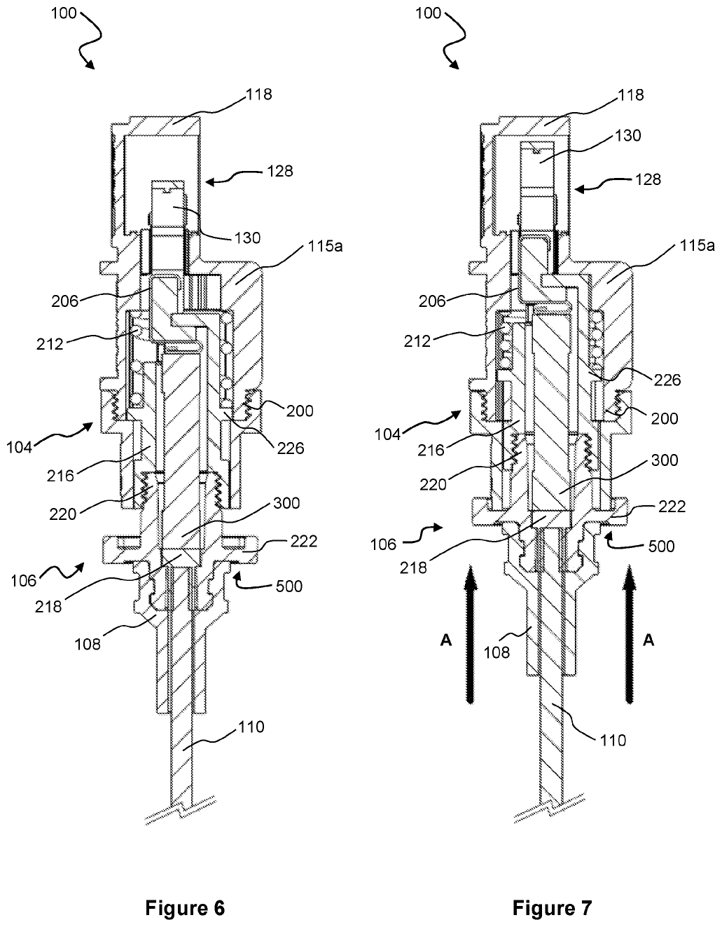

FIG. 2 shows a rear isometric view of the electrical connector 100. FIG. 3 shows a front isometric view of the electrical connector 100. Both FIG. 2 and FIG. 3 show the electrical connector 100 in a fully assembled form. When assembled, the stem 113 is partially obscured by the overlapping cap 112. The cap 112 is slidably mounted on the stem 113, allowing the cap 112 to move relative to the stem 113, as will be described in more detail with reference to FIGS. 6 and 7. When assembled, the electrical wire 110 (or electrical cable) is disposed within the stem 113, as will be described in more detail with reference to FIG. 5.

The roof 118 of the main body 102 comprises a front face 129, a rear face 124, a right slanted face 120a, a left slanted face 120b and a peak face 122. The front face 129 is connected to the rear face 124 by the right slanted face 120a, the left slanted face 120b and the peak face 122. A volume formed between the front face 129, the rear face 124, the right slanted face 120a, the left slanted face 120b and the peak face 122 defines an interior of the main body 102. The peak face 122 comprises an outcrop 122a.

As shown in FIG. 3, the main body 102 comprises an opening 128 in communication with the interior of the main body 102. The interior of the main body 102 houses the electrically conductive contact 130. The main body 102 surrounds the electrically conductive contact 130 on all sides apart from the opening 128. The contact 130 is enclosed by the main body 102 and is only accessible through the opening 128 of the main body 102. In the arrangement shown in FIG. 3, the main body 102 comprises a single opening such that the main body surrounds the contact 130 on all sides apart from the single opening. As such, a single access point to the contact 130 is provided. This arrangement decreases the risk of the user accidentally touching the contact 130 when handling the electrical connector 100.

The opening 128 is substantially circular in shape. The opening 128 is positioned on the front face 129 of the roof 118. In some embodiments, the opening 128 comprises a second v-shaped protrusion 103. The second v-shaped protrusion 103 extends from an inner edge of the opening 128.

The first shoulder 105 comprises a first shelf 116a and a second shelf 116b. The first shelf is positioned on one side of the neck 119 and the second shelf 116b is positioned on the opposite side of the neck 119. The first shelf 116a and the second shelf 116b are wide enough to allow a user to place one finger on the first shelf 116a and a second finger on the second shelf 116b. The first shoulder 105 may be used to move the cap 112 relative to the stem 113, as will be described in more detail below.

The main body 102 further comprises a finger guard 114. The finger guard 114 is substantially L-shaped, having a vertical portion 115a and a horizontal portion 115b. A first end of the vertical portion 115a is connected to the first shoulder 105 and a second end of the vertical portion 115a is connected to the horizontal portion 115b. A first end of the horizontal portion 115b is connected to the second end of the vertical portion 115a and a second end of the horizontal portion 115b is connected to the front face 129 of the roof 118.

FIG. 4a shows a rear side view of the electrical connector 100. FIG. 4b shows a cross-sectional view of the electrical connector 100 along a plane X depicted in FIG. 4a. The cross-sectional view of FIG. 4b shows the inside of a fully assembled electrical connector 100.

When assembled, the main body 102 is connected to the collar 104. More specifically, the first threaded connector 200 of the main body 102 is engaged with the second threaded connector 310 of the collar 104. To assemble the cap 112, the user can screw the collar 104 onto the main body 102 (or vice versa, i.e. the user can screw the main body 102 onto the collar 104). In an alternative embodiment, the main body 102 may be integrally formed with the collar 104.

The assembly of the stem 113 will now be described in more detail. When assembled, the strain-relief gland 108 is connected to the base portion 106 and the base portion 106 is connected to the fuse holder 216.

The strain-relief gland 108 is connected to the retaining portion 224 of the base portion 106. For example, the strain-relief gland 108 can be slightly flexible, thus allowing it to be pushed onto the retaining portion 224. The raised ridge 224a of the retaining portion 224 maintains the strain-relief gland 108 in position, preventing it from sliding off the retaining portion 224. The strain-relief gland 108 protects the electrical wire 110 by holding it securely in place, enabling it to withstand bending, knotting, and twisting without letting the strain travel all the way to an end of the electrical wire 110, which is more susceptible to breakage or damage.

The base portion 106 is connected to the fuse holder 216. More specifically, the fourth threaded connector 220 of the base portion 106 is engaged with the third threaded connector 320 of the fuse holder 216. To assemble the stem 113, the user can screw the base portion 106 onto the fuse holder 216.

The cap 112 is slidably connected to the stem 113. In the portrayed embodiment, the cap 112 is positioned over the stem 113, such that the cap 112 partially overlaps the stem 113. The cap 112 is prevented from becoming separated from the stem 113 by the interaction between the annular shoulder 226 of the fuse holder 216 and the collar 104. The annular shoulder 226 blocks the collar 104 from traveling upwards and passing over an end of the fuse holder 216. In this manner, the annular shoulder 226 limits the maximum vertical displacement of the cap 112 relative to the stem 113. The cap 112 may be slidably connected to the stem 113 by snap-fitting these two elements together. Alternatively, the user may place the main body 102 over the stem 113, such that the first threaded connector 200 is level with, or projects below, the annular shoulder 226. Subsequently, the collar 104 may be connected to the first threaded connector 200 using the second threaded connector 310. In this position the collar 104 abuts the bottom of the annular shoulder 226, thus preventing the collar 104 from traveling beyond the annular shoulder 226.

The spring 212 is positioned between the annular shoulder 226 of the fuse holder 216 and an upper interior surface of the main body 102. More specifically, a first end of the spring 212 sits on top of the annular shoulder 226 and a second end of the spring 212 abuts the upper interior surface of the main body 102. In this manner, the spring 212 urges the cap 112 away from the stem 113.

In the fully assembled electrical connector 100, the electrically conductive contact 130 is disposed within the interior of the main body 102. The electrically conductive contact 130 is connected to the stem 113 of the housing 111. More specifically, the clasp 204 of the electrically conductive contact 130 is mechanically connected to the fuse holder 216. The clasp 204 of the electrically conductive contact 130 is also connected to the first fuse connector 206. More specifically, the clasp 204 of the electrically conductive contact 130 is electrically connected to an end of the first fuse connector 206.

The assembled electrical connector 100 further comprises a fuse 300. The fuse is disposed within the fuse chamber 214 and a cavity 302, wherein the cavity 302 is defined by inner walls of the fourth threaded connector 220 and a top surface of the second fuse connector 218. The fuse 300 is electrically connected between the first fuse connector 206 and the second fuse connector 218. As shown in FIG. 4b, the first fuse connector 206 comprises a folded metal strip. Preferably, the folded metal strip comprises a beryllium-copper strip. The first fuse connector 206 is slightly flexible due to the flexibility of the folded metal strip. The resilient nature of the first fuse connector 206 urges the fuse 300 against the second fuse connector 218. By causing the first fuse connector 206 to urge the fuse 300 against the second fuse connector 218, a good electrical connection is maintained between the fuse connectors 206, 218 and the fuse 300.

The second fuse connector 218 is electrically coupled to an end of the electrical wire 110. The electrical wire 110 may be connected to an electrical equipment (not shown). The electrical equipment may comprise any type of electrical load. In some use cases, the electrical equipment is used in the rail industry. For example, the electrical equipment may be used to control signalling lights, track points, points heaters, level crossings or similar. Additionally or alternatively, the electrical equipment may comprise switchgear equipment, communications equipment and/or monitoring equipment.

In summary, once the electrical connector 100 is fully assembled, a circuit is created between the electrically conductive contact 130, the first fuse connector 206, the fuse 300, the second fuse connector 218, the electrical wire 110 and an electrical equipment (not shown). The electrical connector is connectable to an electrical terminal, as will be described in more detail with reference to FIGS. 8a and 8b.

The fuse 300 is configured to break the circuit if a fault in the system leads to an overcurrent flowing through the fuse. This protects the electrical equipment from becoming damaged. The structure of the electrical connector 100 is especially advantageous, as it allows the fuse 300 to be easily installed and replaced. The fuse 300 does not have to be installed separately from the electrical equipment and no intrusive installation is required. Instead, a user can simply disconnect the base portion 106 from the fuse holder 216 (e.g. by unscrewing the fuse holder 216 from the base portion 106), place the fuse 300 into the cavity 302 and connect the base portion 106 back onto the fuse holder 216 (e.g. by screwing fuse holder 216 onto the base portion 106). If a fuse 300 is to be replaced, the user disconnects the base portion 106 from the fuse holder 216, removes the old fuse 300 from the cavity 302 and places a new fuse into the cavity 302. The user can subsequently connect the base portion 106 back onto the fuse holder 216. The cavity 302 is especially useful, as it safely retains the fuse 300 during the installation or replacement process. Specifically, the cavity 302 prevents the fuse 300 from dropping out of the base portion 106 during the replacement or installation process.

The user can even replace or install the fuse 300 when the electrically conductive contact 130 is connected to a live electrical terminal 610 (shown in FIGS. 8a and 8b). The user can simply place the fuse into the cavity 130 and use the base portion 106 of the stem 113 to push the fuse against the first electrical connector 206. The base portion 106 is subsequently connected to the fuse holder 216, without the user having to touch any electrically conductive elements.

With reference to FIG. 5, a method of inserting the electrical wire 110 into the electrical connector 100 and electrically connecting the electrical wire 110 to the second fuse connector 218 will now be described. FIG. 5 shows a partially exploded rear isometric view of the electrical connector 100. Some elements of the electrical connector 100 have been removed for clarity.

Firstly, the base portion 106 is disconnected from the fuse holder 216. This can be achieved by unscrewing the fourth threaded connector 220 of the base portion 106 from the third threaded connector 320 of the fuse holder 216. Subsequently, the electrical wire 110 is inserted through the strain-relief gland 108 and the base portion 106. Using wire strippers, the insulation on an end of the electrical wire 110 is stripped back, to expose a wire core 700. The insulation on an end of the electrical wire 110 may be stripped back by approximately 6 to 7 mm. The wire core 700 is inserted into a tubular interior 702 of the second fuse connector 218. In this embodiment, the second fuse connector 218 is a crimp terminal. Once inserted, a standard crimp tool (not shown) is used to compress/swage the second fuse connector 218 onto the electrical wire 110 to make a solid electrical connection. Lastly, the strain-relief gland 108 is connected to the retaining portion 224 of the base portion 106.

In the above example, the electrical wire 110 is indirectly electrically connected to the contact 130 via the first fuse connector 206, the fuse 300 and the second fuse connector 218. In alternative arrangements, for example in which no fuse is present, the contact 130 and the electrical wire 110 may be directly electrically connected. In such arrangements, once the electrical connector 100 is fully assembled, a circuit is created between the electrically conductive contact 130, the electrical wire 110 and an electrical equipment.

The cap 112 is slidably moveable relative to the stem 113, as will now be described with reference to FIGS. 6 and 7.

FIG. 6 shows a cross-sectional view of the electrical connector 100 in an uncompressed position. FIG. 7 shows a cross-sectional view of the electrical connector 100 in a fully compressed position.

In the uncompressed position, the cap 112 is urged away from the stem 113 by the spring 212. In this position, the opening 128 of the main body 102 is not aligned with the aperture 202 of the electrically conductive contact 130. In some embodiments, the aperture 202 of the electrically conductive contact 130 is fully hidden within the interior of the main body 102. In the depicted embodiment, the aperture 202 of the electrically conductive contact 130 is partially visible through the opening 128 in the uncompressed position.

To move the electrical connector from the uncompressed position towards the fully compressed position, the user places a first finger on the first shelf 116a of the first shoulder 105, a second finger on the second shelf 116b of the first shoulder and a thumb underneath the second shoulder 222. The position of the thumb is shown as a thumb position 500. The electrical connector 100 is then operated by squeezing the thumb and fingers together to compress the spring 212. This action moves the stem 113 towards the cap 112, in a direction depicted by an arrow A shown in FIG. 7.

During this process, the fourth threaded connector 220 of the base portion 106 and the fuse holder 216 slide further into the collar 104 and the main body 102 of the cap 112.

In the fully compressed position, the opening 128 of the main body 102 is aligned with the aperture 202 of the electrically conductive contact 130. In this position, the bottom of the collar 104 abuts a top surface of the second shoulder 222. The collar 104 cannot travel past the second shoulder 222. This limits how much a user can compress the electrical connector 100.

If the user stops applying the compressive force, the cap 112 is again urged away from the stem 113 by the spring 212. The electrical connector 100 returns to the uncompressed position.

A method of attaching the electrical connector 100 to an electrical terminal will now be described with reference to FIGS. 8a and 8b.

In this embodiment, an electrical terminal 610 comprises a bolt. The electrical terminal 610 comprises a head 600 connected to a shank 604. The shank 604 comprises a thread 606. A nut 602 is connected to the shank 604 of the electrical terminal 610. The shank 604 may be inserted through a backboard (not shown) of a railway Signalling Apparatus Housing, such that the head 600 and the nut 602 are on opposite sides of the backboard. The electrical terminal 610 is held in place on the backboard by the nut 602. The electrical terminal 610 may be connected to a power supply on the side of the backboard on which the head 600 is disposed. The shank 604 of the electrical terminal 610 protrudes through the backboard, thus allowing the electrical connector 100 to be connected thereto.

The electrical terminal 610 may instead take other forms. For example, the electrical terminal 610 may comprise a stud, a screw or a rod. The electrical terminal may comprise a smooth (non-threaded) shank. In some embodiments, the electrical terminal 610 may not comprise the nut 602.

The electrical terminal 610 may be live. For example, the electrical terminal 610 may be connected to an external power supply (not shown).

To connect the electrical connector 100 to the electrical terminal 610, the user moves the electrical terminal into the fully compressed position, shown in FIG. 7. In this position the aperture 202 is aligned with the opening 128. The main body 102 is placed over the electrical terminal 610, such that the shank 604 of the electrical terminal 610 is inserted through the opening 128 and into the aperture 202. Because the electrical connector 100 is connected to the electrical wire 110 (which is in turn electrically connected to the electrical equipment), the electrical connector is freely moveable. This allows the user/installer to easily locate the opening 128 onto the shank 604 of the electrical terminal 610.

The user subsequently stops applying the compressive force to the electrical connector 100, by removing their fingers and thumb from the first shoulder 105 and the second shoulder 222, respectively. As the electrical connector 100 is urged to return into the uncompressed position under the influence of the spring 212, an internal surface of the opening 128 and an internal surface of the aperture 202 of the contact 130 are configured to apply a compressive force to the shank 604 of the electrical terminal 610. The spring 212 effectively clamps the shank 604 of the electrical terminal 610 between an upper internal surface of the aperture 202 and a lower internal surface of the opening 128.

Once the electrical connector 100 is clamped onto the electrical terminal 610, an electrical connection is formed between the electrical terminal 610, the electrically conductive contact 130, the first fuse connector 206, the fuse 300, the second fuse connector 218, the electrical wire 110 and the electrical equipment (not shown).

The circular shape of the opening 128 and the aperture 202 is especially useful at retaining the cylindrical shank 604 of the electrical terminal 610. This is because the upper internal surface of the aperture 202 and the lower internal surface of the opening 128 provide a large surface area in contact with an outer surface of the shank 604. This ensures that the shank 604 is securely clamped to the electrical connector 100, and cannot become easily disconnected. The circular shape of the aperture 202 of the contact 130 also improves the quality of the electrical connection between the contact 130 and the electrical terminal 610.

The first v-shaped protrusion 201 (shown in FIG. 1) of the aperture 202 and the second v-shaped protrusion 103 (shown in FIG. 3) of the opening 128 can further improve both the electrical and the mechanical connection between the electrical connector 100 and the electrical terminal 610.

The first v-shaped protrusion 201 and the second v-shaped protrusion 103 can be used to scrape away any impurity layers that coat the outer surface of the shank 604. For example, the first v-shaped protrusion 201 and the second v-shaped protrusion 103 can remove any dirt or corrosion from the shank 604, as the shank 604 is inserted through the opening 128 and into the aperture 202. This further improves the quality of the electrical connection between the contact 130 and the electrical terminal 610. The first v-shaped protrusion 201 and the second v-shaped protrusion 103 can also engage with the threaded surface 606 of the electrical terminal 610, thereby improving the mechanical connection between the electrical connector 100 and the electrical terminal 610.

The structure of the cap 112 and the stem 113 is specifically designed to allow the electrical connector 100 to be safely connected to the live electrical terminal 610. The outcrop 122a, the right slanted face 120a and the left slanted face 120b discourage the user from attempting to place their fingers on the roof 118 when moving the cap 112 relative to the stem 113. Placing the fingers on the roof 118 could be dangerous, as in this position the user could accidentally touch the live electrical terminal 610. By designing the shape of the roof 118 in this manner, the user is encouraged to only place their fingers/thumb on the designated first shelf 116a, the second shelf 116b and under the second shoulder 222 in position 500. The finger guard 114 further protects the user from accidentally touching the live electrical terminal 610. The finger guard 114 creates a barrier between the first shelf 116a, the second shelf 116b and the live electrical terminal 610, as the user moves the cap 112 relative to the shaft 113.

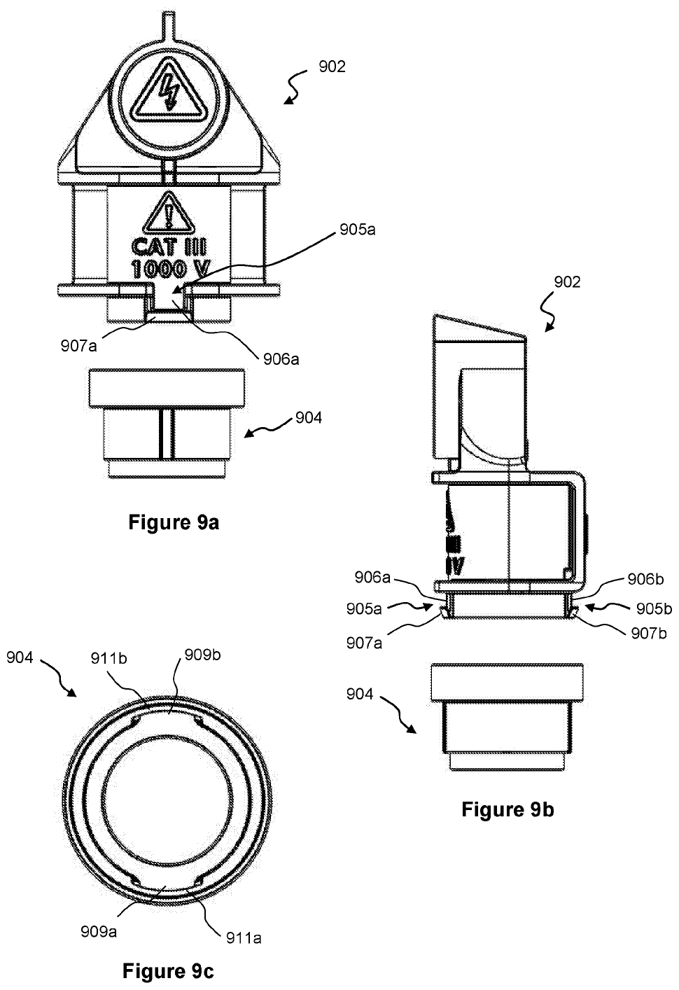

FIGS. 9a and 9b show an alternative main body 902 and collar 904. The main body 902 and 904 comprise similar features to those described above in respect of the main body 102 and the collar 104 respectively, but comprise a different connection mechanism to the first and second threaded connectors 200, 310 of the main body 102 and the collar 104. FIG. 9a shows a rear side view of the main body 902 and the collar 904. FIG. 9b shows a side view of the main body 902 and the collar 904.

The main body 902 shown in FIGS. 9a and 9b comprises retaining clips 905a, 905b configured to engage corresponding retention features on the collar 904, to couple the main body 902 thereto. In the arrangement shown in FIGS. 9a and 9b, the main body 902 comprises two, opposed retaining clips 905a, 905b, however the skilled person will appreciate that other numbers of retaining clips may be used in alternative arrangements. The retaining clips 905a, 905b may comprise arms 906a, 906b and lugs 907a, 907b. The lugs 907a, 907b may be configured to engage the corresponding retention features on the collar 904, which may be retention recesses, apertures, lips or shoulders, to couple the main body 902 to the collar 904. For example, the lugs 907a, 907b may locate in a retention recess or aperture, or else abut a lip or shoulder to prevent axial and/or rotational movement of the main body 902 relative to the collar 904. The corresponding retention features may be located on an internal surface of the collar 904. The skilled person will appreciate that in alternative arrangements, however, the retaining clips 905a, 905b may be located on the collar 904 and the corresponding retention features may be located on the main body 902.

The arms 906a, 906b may be resiliently deformable. As such, when the user couples the main body 902 to the collar 904, the arms 906a, 906b may be pushed radially inwards as the lugs 907a, 907b ride along the internal surface of the collar 904. When the lugs 907a, 907b align with the corresponding retention features, the arms 906a, 906b return to their non-deformed state such that the lugs 907a, 907b locate within the respective corresponding retention features to couple the main body 902 and the collar 904.

FIG. 9c shows a top view of the collar 904. The collar 904 comprises reaction surfaces 909a, 909b. The reaction surfaces 909a, 909b may be angled radially inwardly with respect to a longitudinal axis of the collar 904. The lugs 907a, 907b may be configured to ride over the reaction surfaces 909a, 909b to push the arms 906a, 906b radially inwards. The corresponding retention features on the collar 904 may be provided by rims 911a, 911b. Once the lugs 907a, 907b move clear of the respective rims 911a, 911b, the arms 906a, 906b move into their non-deformed state such that the lugs 907a, 907b engage the underside of the respective rims 911a, 911b.

Advantageously, by using a clip arrangement such as the one shown in FIGS. 9a to 9c, the user is deterred from disconnecting the main body 902 from the collar 904, since the clip arrangement is more difficult to disengage than, for example, the threaded connector arrangement. The user is therefore less likely to gain access to the components located within the interior of the main body 902, such as the electrical contact 130, providing a further safety mechanism. The skilled person will appreciate that alternative connection mechanisms may be used, such as latches, bolts etc.

It will be understood that the invention has been described above purely by way of example, and that modifications of detail can be made within the scope of the claims. Although the electrical connector has been described with reference to specific applications in the railway industry, it should be appreciated that the electrical connector can be used in other contexts and industries. For example, the electrical connector disclosed herein can be used for low-voltage and/or low-current applications in which the risk of a user receiving an electric shock is of lesser concern.

1. An electrical connector for connecting an electrical equipment to an electrical terminal, the electrical connector comprising:
an electrically insulating housing having a single opening in communication with an interior of the housing; and
an electrically conductive contact disposed within the interior of the housing and accessible via the opening, the contact having an aperture for receiving the electrical terminal, wherein the housing surrounds the contact on all sides apart from the opening, and
wherein the contact is moveable relative to the housing between a first position and a second position, the first position permitting the electrical terminal to be inserted through the opening and into the aperture, and the second position configured to retain the electrical terminal in the aperture.

2. (canceled)

3. The electrical connector of claim 1, wherein the aperture of the contact is circular and the opening of the housing is circular.

4. (canceled)

5. The electrical connector of claim 1, wherein the aperture of the contact is aligned with the opening of the housing when the contact is in the first position.

6. The electrical connector of claim 1, wherein the opening of the housing and/or the aperture of the contact comprise a surface feature for engaging with an external surface of the electrical terminal.

7. The electrical connector of claim 6, wherein the surface feature comprises a v-shaped protrusion for engaging with a screw thread on the external surface of the electrical terminal.

8. The electrical connector of claim 1, wherein the housing and an internal surface of the aperture of the contact are configured to apply a compressive force to the electrical terminal when the contact is in the second position.

9. The electrical connector of claim 1, further comprising a biasing mechanism configured to urge the contact towards the second position.

10. The electrical connector of claim 9, wherein the housing and an internal surface of the aperture of the contact are configured to apply a compressive force to the electrical terminal when the contact is in the second position, and wherein the biasing mechanism is configured to clamp the electrical terminal between the housing and the internal surface of the aperture of the contact.

11. (canceled)

12. The electrical connector of claim 1, wherein the housing comprises:
a stem; and
a cap at least partially overlapping the stem and having the opening, wherein the cap is slidably mounted on the stem.

13. The electrical connector of claim 12, wherein the contact is connected to the stem and is disposed within the cap.

14. The electrical connector of claim 13, wherein both the contact and the stem are moveable relative to the cap between the first position and the second position.

15. The electrical connector of claim 12, further comprising a biasing mechanism configured to urge the contact towards the second position, wherein the biasing mechanism is configured to urge the cap away from the stem.

16. The electrical connector of claim 1, wherein the housing comprises one or more formations to enable a user to move the contact between the first position and the second position.

17. The electrical connector of claim 12, wherein the housing comprises one or more formations to enable a user to move the contact between the first position and the second position, and wherein the one or more formations comprise:
a first shoulder coupled to the cap; and
a second shoulder coupled to the stem.

18. The electrical connector of claim 17, further comprising a finger guard coupled to the first shoulder and configured to prevent the user from touching the electrical terminal when moving the contact between the first position and the second position.

19. The electrical connector of claim 12, wherein the stem comprises a fuse holder for receiving a fuse.

20. The electrical connector of claim 19, wherein the electrical connector further comprises a fuse disposed within the fuse holder, wherein the fuse is connectable between the electrical equipment and the contact.

21. (canceled)

22. The electrical connector of claim 20, wherein the fuse is replaceable when the contact is in the second position.

23. The electrical connector of claim 19, further comprising:
a first fuse connector, connectable between the contact and the fuse, and
a second fuse connector, connectable between the fuse and the electrical equipment,
wherein the first fuse connector is configured to urge the fuse against the second fuse connector.

24. The electrical connector of claim 12, wherein the cap comprises a main body comprising the opening, and a collar,
wherein one of the main body and the collar comprises at least one retaining clip configured to engage with a corresponding retention feature located on the other of the main body and the collar to connect the main body and the collar.

25. (canceled)

26. (canceled)
